(19) United States
(12) Patent Application Publication
(10) Pub. No.: US 2010/0063901 A1
(43) Pub. Date: Mar. 11, 2010

(54) Oilfield Inventory control and Communication System

(76) Inventors: Sean Paul Brierley, Houston, TX (US); Paul Douglas Hanks, Manvel, TX (US); Leonard R. Case, Duncan, OK (US); Rory Dennis Daussin, Spring, TX (US)

Correspondence Address: JOHN W. WUSTENBERG, P.O. BOX 1431, DUNCAN, OK, 73536, US

(21) Appl. No.: 12/207,604

(22) Filed: Sep. 10, 2008

(51) Int. Cl. G06Q 10/00

(52) U.S. Cl. 705/28

(57) ABSTRACT

Methods and apparatuses for providing inventory visibility and on site material control to support services provided at a well site are disclosed. A system for communicating inventory information is provided. The system includes a mobile storage unit and a load cell coupled to the mobile storage unit. The load cell generates an electric signal representing the amount of materials in the mobile storage unit. A command center is communicatively coupled to the load cell. The command center receives a signal from the load cell representing the amount of materials in the mobile storage unit.

### BACKGROUND

The present invention relates generally to oilfield operations, and more particularly to methods and apparatuses for providing inventory visibility and on site material control to support services provided at a well site.

The servicing and stimulation of wells is a complex process that involves a series of coordinated operations that begin with the supply by truck of equipment, supplies, fuel, and chemicals to the well head. The equipment is set-up and made ready with proppant and chemicals. After completion of the well services, equipment must then be broken down and made ready for transport to the next pad for service.

On land, stimulation and treatment processes are often performed with mobile equipment that may be in place for a short period of time. Equipment may then be moved by truck(s) from pad to pad as necessary. The movement of equipment and personnel makes it difficult to manage the availability of chemicals, proppants, and equipment as needed. In addition, the supply of materials is often limited by truck capacity to supply well operation sites.

A number of different materials are used during oilfield operations. For instance, a number of liquid chemicals, including crosslinkers, gelling agents, viscosity altering chemicals, pH buffers, modifiers, surfactants, breakers, and stabilizers or dry materials (e.g., proppant materials comprising sands and other particulates with compositions including bauxites, ceramics, glasses, plastics, metals, natural materials such as walnut seed particulates, resin composites, etc.), may be utilized during the oilfield operations. These materials are often stored in storage units at the job site. As the materials are used and the amount of materials available in the storage unit(s) is reduced, it is necessary to replenish the contents of the storage units. Trucks are often used to deliver the requisite materials to the storage units to ensure a constant supply of materials necessary for performing a job.

The current methods of maintaining a constant supply of materials in a storage unit have several disadvantages. First, due to a lack of visibility the real-time understanding of material availability in the storage units is limited. Consequently, it is often necessary to retain a line of trucks ready to deliver the requisite materials to the storage units as soon as the amount of a particular material in a storage unit is below a desired amount. Moreover, many oilfield operations are performed in remote areas. Due to the long period of time necessary for delivering materials to such remote areas, an oilfield operator cannot request the requisite materials as they become depleted and is instead forced to retain a number of trucks containing the requisite supplies to ensure the operations can be performed in a timely manner. Another drawback of the current methods is the inability to monitor and control job site inventories from a remote location.

Additionally, the current methods of maintaining a constant supply of materials are expensive and resource intensive, as an oilfield operator has to take on the expenses and resources associated with maintaining a number of trucks on standby for each job site.

### FIGURES

Some specific example embodiments of the disclosure may be understood by referring, in part, to the following description and the accompanying drawings.

FIG. 1 is a diagram of an oilfield operation in accordance with an exemplary embodiment of the present invention.

FIG. 2 is a diagram of an oilfield inventory control and communication system in accordance with another exemplary embodiment of the present invention.

FIG. 3 is an exemplary graphical representation of the inventory at different job sites.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention relates generally to oilfield operations, and more particularly to methods and apparatuses for providing inventory visibility and on site material control to support services provided at a well site.

In one embodiment, the present invention is directed to a system for communicating inventory information comprising: a mobile storage unit; a load cell coupled to the mobile storage unit, wherein the load cell generates an electric signal representing the amount of materials in the mobile storage unit; and a command center communicatively coupled to the load cell, wherein the command center receives a signal from the load cell representing the amount of materials in the mobile storage unit.

In another exemplary embodiment, the present invention is directed to a method of controlling the inventory at a job site comprising: coupling a mobile storage unit containing a first material to a measurement device; communicating a signal from the measurement device to a command center, wherein the signal represents the amount of the first material in the mobile storage unit; and coordinating delivery of the first material to the mobile storage unit if the signal is less than a threshold value.

In yet another exemplary embodiment, the present invention is directed to a system of inventory control comprising: a first job site having a first storage unit containing a first material; wherein a first load cell is coupled to the first storage unit; a second job site having a second storage unit containing a second material; wherein a second load cell is coupled to the second storage unit; and wherein the second job site is located remotely from the first job site; a logistics control center communicatively coupled to the first load cell and the second load cell; and a transportation hub communicatively coupled to the logistics control center.

The features and advantages of the present disclosure will be readily apparent to those skilled in the art upon a reading of the description of exemplary embodiments, which follows.

### DESCRIPTION

The present invention relates generally to oilfield operations, and more particularly to methods and apparatuses for providing inventory visibility and on site material control to support services provided at a well site.

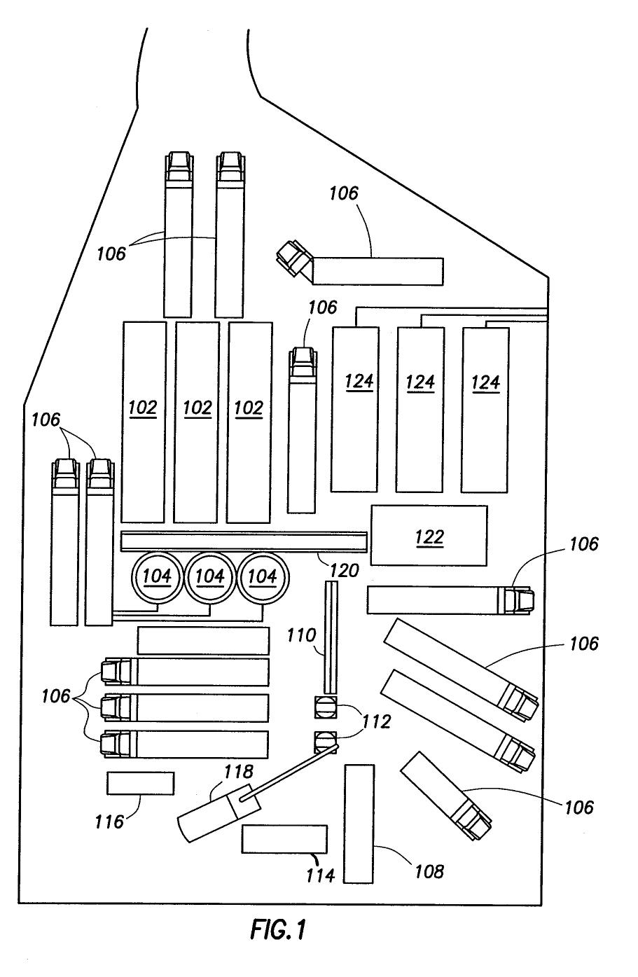

FIG. 1 is a diagram of an oilfield operation in accordance with an exemplary embodiment of the present invention. There are a number of storage units provided on the site. The storage units may include storage tanks 102 for storing dry materials, silos 104 or tanks 124 for storing liquid materials. In one embodiment, the storage tanks 102 comprise vertical storage systems with a small footprint that efficiently utilize the square footage allowed for storage of materials on the job site. For example, the storage tanks 102 may comprise proppant bulk storage containers, including those containers commonly referred to as Mountain Movers™ or Sand Chiefs. A number of trucks 106 deliver the requisite materials to the job site. These materials are then stored in the storage units 102, 104, 124. As would be appreciated by those of ordinary skill in the art, with the benefit of this disclosure, in one embodiment the storage units 102, 104, 124 may be mobile storage units which can be transported from one job site to another as necessary. In an embodiment, a command center 108 is located near the manifold 110 and the well head 112. As would be appreciated by those of ordinary skill in the art, with the benefit of this disclosure, in one embodiment, the command center 108 may be a Technical Command Center located at the well site. In another exemplary embodiment (not shown), a command center 108 may be located at a location remote from the well site and well head 112. For example, a command center 108 may be used to monitor, guide, or control from a central location within a large oilfield from about 1-2 miles from the well site to about 200 miles from the well site. In another exemplary embodiment, operations command may be performed from a remotely located Real-time Operations (RTO) center (not shown), optionally with a command center 108. RTO centers are generally located around the world to monitor, guide, and control operations across very broad regions that may include countrywide areas. Additionally, RTO centers may be utilized to monitor, guide, or control operations remotely from one location to any other global location. A hydraulic power unit 114, a lubrication trailer 116 and a wireline crane 118 may also be situated near the well head 112 and be utilized during the oilfield operations. A batch conveyor 120 may be used to convey the materials from the storage units 102, 104 to the batch station 122 where the materials may be mixed before being used in the oilfield operations. The storage units will be equipped with load cells (not shown). Each load cell generates an electric signal representing the amount of materials in the storage unit coupled thereto.

During oilfield operations in an oilfield system arranged in accordance with an embodiment of the present invention, the load cells are communicatively coupled to the command center 108 or a RTO center. The load cells may include the software to communicate the on site inventories to the command center 108 for the purpose of servicing the different activities surrounding oilfield operations. In one embodiment, the load cells may be communicatively coupled to the command center 108 or a RTO center through an existing on site satellite communications system. In another exemplary embodiment, the load cells may communicate with the command center 108 or a RTO center through a wireless wide area network. In an embodiment, the load cells may be communicatively coupled to a command center 108 through a wired communications system, and optionally, the command center 108 communicatively coupled to a RTO center by a satellite communications system or a wireless wide area network communications system. As would be appreciated by those of ordinary skill in the art, with the benefit of this disclosure, the wireless wide area network may also comprise worldwide interoperability for microwave access (WIMAX) technology. In another exemplary embodiment, the wireless wide area network may also comprise the wireless physical interface provisions of 3.5 generation (3.5G) wireless communication systems or of 4 generation (4G) wireless communication systems. In yet another exemplary embodiment, once the information from the load cell is received in the command center 108 it may be relayed over the World Wide Web allowing access to inventory information to any authorized user or through any authorized terminal having access to the internet. In one embodiment the authorized terminal may be a computer.

Hence, the command center 108 or RTO center will receive information relating to the existing inventory of materials in the various storage units 102, 104, 124. The logistics personnel with secure internet access may then view this information on the site from anywhere in the world to determine the amount of different materials that may be needed at the site in real-time. Based on that information, the logistics personnel may efficiently utilize the transport providers to deliver the requisite materials to the job site in a timely and efficient manner.

As would be appreciated by those of ordinary skill in the art, with the benefit of this disclosure, the load cells may also be used to control metering rates from the storage units 102, 104, 124 during on site service activities such as cementing, stimulation or acid treatments. In one embodiment, this information may be communicated to the command center 108 or RTO center and used to display and record the amount of materials used during the operations thereby allowing on site billing.

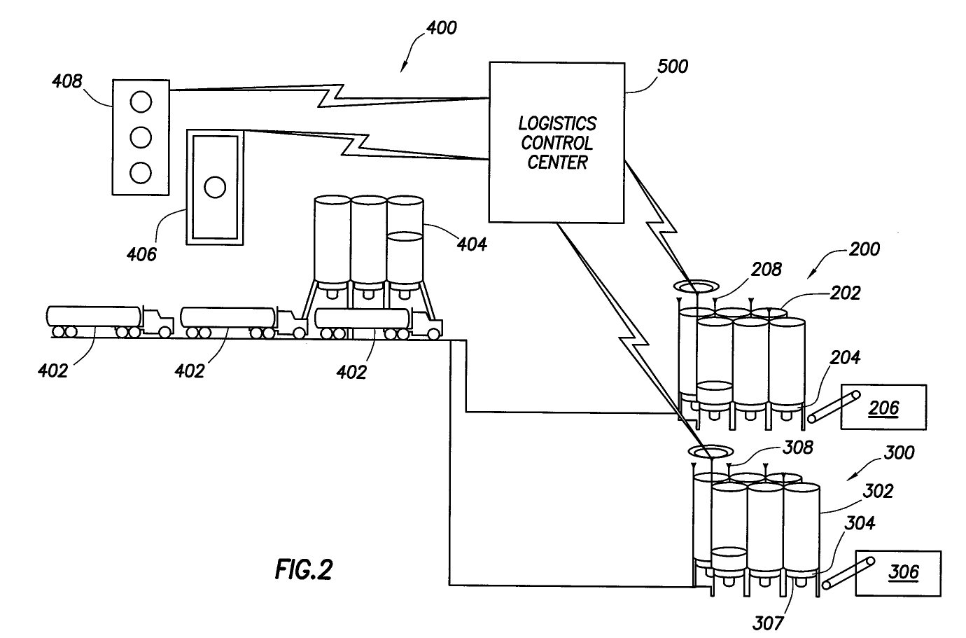

FIG. 2 depicts and oilfield control and communication system in accordance with another exemplary embodiment of the present invention. The system includes a first job site 200, a second job site 300 and a transportation hub 400 which may be located remotely from the job sites 200, 300. The first job site 200 includes a plurality of storage units 202 for storing a number of different liquids and/or dry materials. Each storage unit 202 is coupled to a load cell 204 and a batch station 206. The load cells 204 are communicatively coupled to a logistics control center 500 through the communication device 208. In an embodiment, the load cells 204 may be communicatively coupled to a logistics control center 500 through a wired communication system, and optionally, the logistics control center 500 may be communicatively coupled to a RTO center by a satellite communications system or a wireless wide area network communications system. The first job site 200 may also include a number of additional components (not shown) similar to those depicted in FIG. 1. Similarly, the second job site 300 may include a plurality of storage units 302 for storing a number of different liquids and/or dry materials. As would be appreciated by those of ordinary skill in the art, with the benefit of this disclosure, in one embodiment the storage units 202, 302 may be mobile storage units which can be transported from one job site to another, as necessary. Each storage unit 302 is coupled to a load cell 304 and a batch station 306. The load cells 304 are communicatively coupled to a logistics control center 500 through the communication device 308. In an embodiment, the load cells 304 are communicatively coupled to a logistics control center 500 through a wired communication system, and optionally, the logistics control center 500 communicatively coupled to a RTO center by a satellite communications system or a wireless wide area network communications system. The second job site 300 may also include a number of additional components (not shown) similar to those depicted in FIG. 1.

The first job site 200 and the second job site 300 may communicate the information from the load cells 204, 304 to the logistics control center 500 through the communication device 208, 308 in a number of ways. In one exemplary embodiment, the load cells may communicate with the command center 108 through a wireless wide area network. As would be appreciated by those of ordinary skill in the art, with the benefit of this disclosure, the wireless wide area network may also comprise worldwide interoperability for microwave access (WIMAX) technology. In another exemplary embodiment, the wireless wide area network may also comprise the wireless physical interface provisions of 3.5 generation (3.5G) wireless communication systems or of 4 generation (4G) wireless communication systems. In another exemplary embodiment, the load cells may communicate with the command center 108 through a wired communications system. In yet another exemplary embodiment, once the information from the load cell is received in the command center, it may be relayed over the World Wide Web allowing access to inventory information to any authorized user or through any authorized terminal having access to the internet.

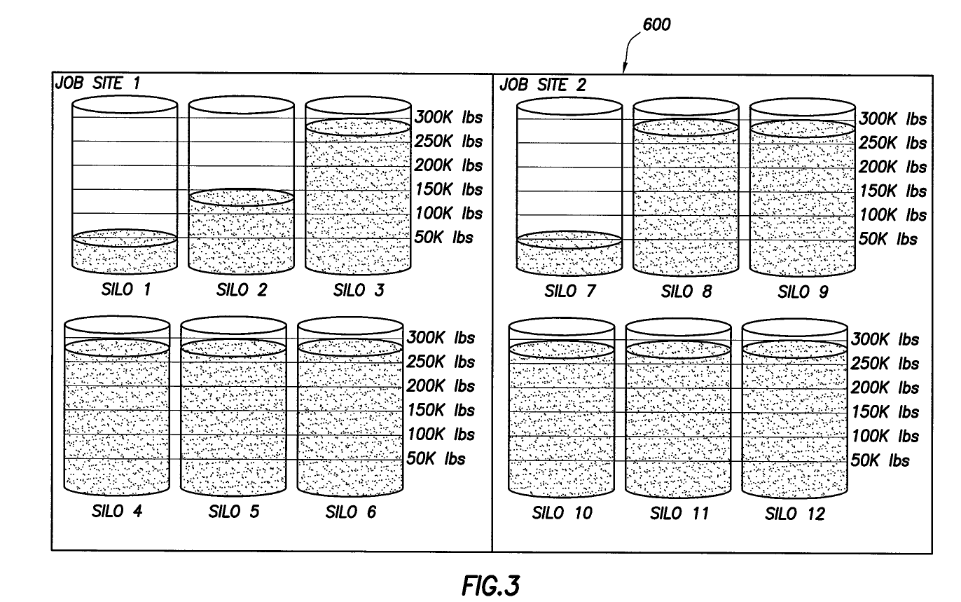

The information received at the logistics control center 500 may be represented to the logistics personnel remotely who may then interpret that information and use it to coordinate the activities of the transportation providers to fulfill the material demands of the different job sites 200, 300. As would be appreciated by those of ordinary skill in the art, with the benefit of this disclosure, the information communicated from the load cells may be represented in a number of ways at the logistics control center 500. In one embodiment, the information from the different job sites may be graphically represented as depicted in FIG. 3.

The logistics personnel may then use the information received at the logistics control center 500 to coordinate the activities at a transportation hub 400 providing a dynamic distribution model to the job sites. In one embodiment, a number of trucks 402 from the transportation providers may be retained in a standby queue at the transportation hub 400. As depicted in FIG. 2, the transportation hub 400 may be situated so as to be able to serve a number of different job sites, thereby improving the efficiency of the operations. The transportation hub 400 may include a loading point 404 where the materials that may be required during the oilfield operations at the different job sites 200, 300 are stored before being transferred to the trucks 402.

A communication system similar to that between the job sites 200, 300 and the logistics control center 500 may be used for communication from the logistics control center 500 to the transportation hub 400. As would be appreciated by those of ordinary skill in the art, with the benefit of this disclosure, although the transportation hub 400 and the logistics control center 500 are depicted as distinct locations, the invention is not limited by the location of logistics control center 500. For example, in another exemplary embodiment, the logistics control center 500 may be located within the transportation hub 400. A user interface at the transportation hub 400 may be utilized to guide the operations of the transport providers. The use of a transportation hub 400, and the added inventory visibility helps ensure a more efficient and timely supply of the materials needed at a particular job site.

Once the inventory of a particular material at a particular job site reaches below a threshold level, the logistics personnel at the logistics control center 500 send a signal to the transportation hub 400. The threshold value may be dependent upon the distance between the transportation hub 400 and the job site 200, 300 as the time it would take to deliver the requisite materials to a job site is a function of the distance between the transportation hub 400 and the job site. Based on the signal received at the transportation hub 400 the next truck 402 available in the queue is loaded with the requisite material at the loading point 404 and directed to the particular job site requiring replenishment.

In one exemplary embodiment, a user interface at the transportation hub 400 may be communicatively coupled to the logistics control center 500 to monitor the job performance at a particular job site. In one embodiment, the user interface may comprise a group of color coded lights 406, 408 which may be used to indicate the inventory requirements of the different job sites 200, 300. For instance, a red light in the indicator 406 corresponding to the job site 200 may indicate that the oilfield operations at the site have been canceled and the truck(s) headed to that job site can be unloaded and returned to the queue or redirected to another job site. A yellow light may be used to indicate that the oilfield operations at the particular job site 200 have been delayed and that the truck(s) headed to that job site can remain on standby or redirected to another job site. Finally, a green light may be used to indicate that the oilfield operations at the job site 200 are continuing as planned and that the truck(s) can continue the delivery of materials to that job site.

Although FIG. 2 depicts only two job sites, as would be appreciated by those of ordinary skill in the art, with the benefit of this disclosure, the system disclosed herein may be similarly applied to an oilfield operation involving any number of job sites. Moreover, as would be appreciated by those of ordinary skill in the art, with the benefit of this disclosure, a number of different devices may be used to monitor the content of the storage units and the tanks and the current invention is not limited to using a load cell. For instance, the amount of materials in the storage units and the tanks may be monitored using a flow meter, a scale, etc. Moreover, the term “transport provider” may include both third party transport providers and transport providers employed by the oilfield operator.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In addition, the terms in the claims have their plain, ordinary meaning unless otherwise explicitly and clearly defined by the patentee.

What is claimed is:

1. A system for communicating inventory information comprising:
a mobile storage unit;
a load cell coupled to the mobile storage unit,
wherein the load cell generates an electric signal representing the amount of materials in the mobile storage unit; and
a command center communicatively coupled to the load cell,
wherein the command center receives a signal from the load cell representing the amount of materials in the mobile storage unit.

2. The system of claim 1, wherein the mobile storage unit is selected from the group consisting of a proppant storage container or a liquid chemicals tank.

3. The system of claim 1, wherein the command center is communicatively coupled to the load cell using one of an on site satellite communication system, a wireless wide area network system, a worldwide interoperability for microwave access system, a 3.5 generation wireless communication system or a 4 generation wireless communication system.

4. The system of claim 1, wherein the command center is located on a well site.

5. The system of claim 1, wherein the command center is not located on a well site.

6. The system of claim 1, wherein the command center is communicatively coupled to one of an authorized user and an authorized terminal over the World Wide Web.

7. A method of controlling the inventory at a job site comprising:
coupling a mobile storage unit containing a desired material to a measurement device;
communicating a signal from the measurement device to a command center,
wherein the signal represents the amount of the desired material in the mobile storage unit; and
coordinating delivery of the desired material to the mobile storage unit if the signal is less than a threshold value.

8. The method of claim 7, wherein the measurement device is a load cell.

9. The method of claim 7, further comprising relaying the signal from the command center over the World Wide Web.

10. The method of claim 9, wherein the signal is relayed over the World Wide Web to one of an authorized user and an authorized terminal.

11. The method of claim 7, wherein the signal is communicated from the measurement device to the command center using a system selected from the group consisting of: an on site satellite communication system, a wireless wide area network system, a worldwide interoperability for microwave access system, a 3.5 generation wireless communication system and a 4 generation wireless communication system.

12. The method of claim 7, further comprising metering a disposal of the desired material from the mobile storage unit.

13. The method of claim 7, wherein the command center is located on a well site.

14. The method of claim 7, wherein the command center is not located on a well site.

15. The method of claim 7, wherein the desired material is made entirely or in part of a solid or a liquid.

16. A system of inventory control comprising:
a first job site having a first storage unit containing a first material;
wherein a first load cell is coupled to the first storage unit;
a second job site having a second storage unit containing a second material;
wherein a second load cell is coupled to the second storage unit; and
wherein the second job site is located remotely from the first job site;
a logistics control center communicatively coupled to the first load cell and the second load cell; and
a transportation hub communicatively coupled to the logistics control center.

17. The system of claim 16, wherein the logistics control center generates a command signal to the transportation hub representing the requirements of the first storage unit and the second storage unit.

18. The system of claim 17, wherein the command signal generated from the logistics control center depends on communication from the first load cell and the second load cell.

19. The system of claim 16, wherein the logistics control center includes a user interface representing the communication from the first load cell and the second load cell.

20. The system of claim 16, wherein a truck at the transportation hub is loaded with one of the first material and the second material and directed to one of the first job site and the second job site depending on a communication from the logistics control center.

21. The system of claim 16, wherein operation of a truck at the transportation hub is dependent on a communication from the logistics control center.
